(19) United States
(12) Patent Application Publication
(10) Pub. No.: US 2005/0254887 A1
(43) Pub. Date: Nov. 17, 2005

(54) Releasable locking mechanism

(75) Inventor: Barry Berhoff, Palm City, FL (US)

Correspondence Address: AKERMAN SENTERFITT, P.O. BOX 3188, WEST PALM BEACH, FL, 33402-3188, US

(73) Assignee: Shurhold Industries, Inc., Palm City, FL (US)

(21) Appl. No.: 10/845,960

(22) Filed: May 14, 2004

(51) Int. Cl. F16B 7/10

(52) U.S. Cl. 403/109.3

(57) ABSTRACT

A locking mechanism for releasably coupling a generally cylindrical shaft to an item. The locking mechanism may be formed from a body having a cavity for receiving a shaft. The cavity may have an inner diameter that is slightly larger than an outside diameter of the shaft for producing a tight fit. The locking mechanism may also include an inner housing positioned in the cavity. The inner housing may include an internal cavity for receiving a locking device. The locking device may include one or more pins biased towards an outer surface of the inner housing. The pin may protrude through a hole in the inner housing and a hole in the body of the locking mechanism.

### FIELD OF THE INVENTION

This invention is directed generally to locking mechanisms, and more particularly to releasable locking devices usable for releasably attaching a shaft to another object.

### BACKGROUND OF THE INVENTION

There exists a multitude of different locking mechanisms for releasably coupling shafts to various items. For example, there exists numerous configurations for releasably attaching a brush block to a handle. Each of these systems relies on having a structurally secure and tight connection between the handle and the brush block. However, many locking mechanisms fail to provide a tight, secure connection, which can be due to manufacturing tolerances. Rather, many locking mechanisms have too much play in the connection, thereby limiting the uses of the brush block. The typical attachment mechanism for securing a shaft to an item such as a brush block comprises a protruding first shaft over which a hollow shaft attached to or forming part of a handle is fitted. This requires both a projecting shaft on the brush block or head, which makes the head bulky to store, and also requires the handle to include a hollow shaft section. The projecting shaft on the brush block or head must typically be formed of metal in order to provide it with enough strength, which increases the manufacturing costs and complexities. A locking mechanism for such an attachment mechanism typically comprises a pin provided on the first shaft that is biased outwardly to fit into an aperture on the hollow shaft section attached to or forming part of the handle. Thus, a need exists for a releasable locking mechanism capable of providing a secure, tight, releasable connection between the locking mechanism and a shaft.

### SUMMARY OF THE INVENTION

This invention is directed to a locking mechanism for securely and releasably coupling a shaft to an item, such as, but not limited to, a brush block, a squeegee, a boat hook, or any other such device. The locking mechanism may be formed from a body having a cavity for receiving at least one shaft. An inner surface of the cavity may be sized slightly larger than an outer diameter of a shaft in order to provide a tight fit between the shaft and a body. The inner surface of the cavity may or may not have a plurality of ribs located on an inner surface of the cavity.

The locking mechanism may include an inner housing positioned in the cavity for containing a locking device. The locking device may be positioned in an internal cavity of the inner housing and may include a pin biased towards an outer surface of the inner housing. In at least one embodiment, the pin may be coupled to a piece of metal forming a spring and may be inserted into the internal cavity. The pin may protrude through a hole in the inner housing and through a hole in the body so that the locking device may be controlled from outside of the locking mechanism.

The locking mechanism is configured to receive a shaft in the cavity. The cavity in the body may be generally cylindrical. In particular, a hollow shaft may be sized to fit between an inner surface of the cavity and an outer surface of the inner housing. The pin may be depressed to allow the shaft to be inserted into the locking mechanism. The shaft may be inserted until a hole in the shaft mates with the location of the pin and enables the pin to protrude through the hole. The pin prevents the shaft from rotating and from being inadvertently removed from the locking mechanism. The shaft may only be removed by first depressing the pin. While the pin prevents the shaft from rotation and inadvertent removal from the locking mechanism, the tight fit between the shaft and the body eliminate substantially all radial play in the connection between the shaft and the locking mechanism. In at least some embodiments, the connection gives the impression that the shaft is permanently connected to the locking mechanism.

An advantage of this invention is that the locking mechanism provides a strong connection with little, or no, radial play in a shaft.

Another advantage of this invention is that the locking mechanism provides a releasable connection enabling the connection to be separated by releasing a pin.

Yet another advantage of this invention is that the locking mechanism is easily adapted to numerous applications with little or no modification.

A further advantage of this invention is that the locking mechanism can be reduced in size compared to conventional locking mechanisms, yet provides a stronger attachment between the shaft and the body.

These and other embodiments will be described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a locking mechanism attached to a cleaning implement according to an embodiment of the invention.

FIG. 2 is a cross-sectional view of the locking mechanism shown in FIG. 1 taken at line 2-2 in FIG. 1.

FIG. 3 is a cross-sectional view of the locking mechanism shown in FIG. 1 taken at line 3-3 in FIG. 1.

### DETAILED DESCRIPTION OF PREFERRED EMBODIMENTS

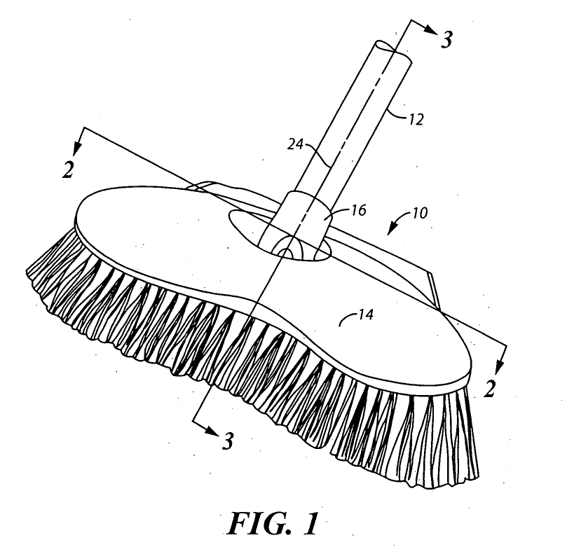

As shown in FIGS. 1-3, this invention is directed to a locking mechanism 10 for attaching a shaft 12, which may be hollow, and which may form a handle, to an item 14, which may include, but is not limited to, a brush block, a squeegee, a boat hook, or any other such device. The locking mechanism 10 may be formed from a body 16 that may be configured to be attachable to numerous different items 14. In at least one embodiment, the body 16 may be configured to be coupled to a brush block 14, as shown in FIG. 1. The locking mechanism 10 is not limited to use with a brush block 14. Instead, the locking mechanism 10 may be used in other applications as well.

The body 16 may include a cavity 18 adapted to receive at least one shaft 12. The cavity 18 may be generally cylindrical, and may have an inner diameter slightly larger than a diameter of the shaft 12 to form a tight fit between the shaft 12 and the body 16. In at least one embodiment, the inner diameter of the cavity 18 may be less than or equal to the diameter of the shaft, thereby creating an interference fit between the shaft 12 and the body 16.

The inner surface 22 may include one or more ribs 20 that may be positioned generally parallel to a longitudinal axis 24 of the cavity 18 or in other positions The ribs 20 may form between about 15 percent and about 35 percent of the inner surface 22 of the cavity 18, and in at least one embodiment, may form about 25 percent of the inner surface 22 of the cavity 18. The ribs 20 may extend a sufficient distance into the cavity, such as between about 0.010 inch and about 0.050 inch from the inner surface 22 towards a longitudinal axis 24. This configuration may produce an interference fit between a shaft 12 and the ribs 20. The interference fit enables the shaft 12 to be held securely in the body 16. In at least one embodiment, the plurality of ribs 20 consists of about eight ribs, which may or may not be spaced equally around the inner surface 22 of the cavity 18.

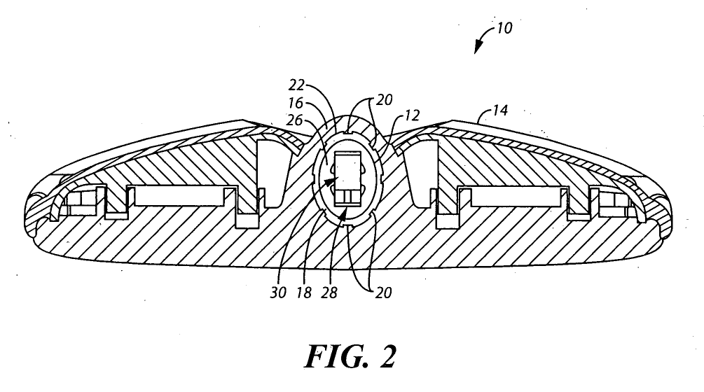

The locking mechanism 10 may include an inner housing 26 in the generally cylindrical cavity 18. The inner housing 26 may include a internal cavity 28 in the inner housing 26 for receiving a locking device 30. The inner housing 26 may have any configuration capable of containing the locking device 30 and enabling a shaft 12 to be inserted into the cavity 18. In at least one embodiment, as shown in FIG. 2, the inner housing 26 may have generally cylindrical cross-section, and the internal cavity 28 may include a generally rectangular cross-section. The inner housing 26 may be formed in one piece with the item 14, and may be formed of any suitable material, such as a plastic material.

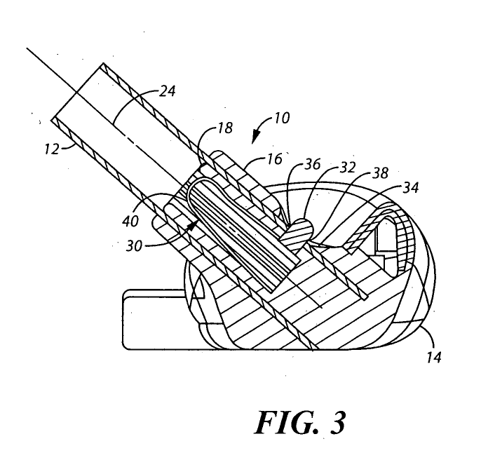

The locking device 30 may be contained in the internal cavity 28, as shown in FIGS. 2 and 3. The locking device 30 may be formed from one or more pins 32 biased towards an outer surface 34 of the inner housing 26, and may be formed of any suitable material, such as metal. In at least one embodiment, the pin 32 may be spring biased. For instance, the pin 32 may be formed from a U-shaped piece of metal 40 having at least one pin 32 coupled to an end of the U-shaped piece of metal 40. The body 16 may include a hole 36, and the inner housing 26 may include a hole 38 aligned with the hole 36 so that the pin 32 may extend from the internal cavity 28 through both the inner housing 26 and the body 16. In this configuration, the pin 32 is capable of extending through a hole in a wall of the shaft 12 to secure the shaft 12 to the body 16. The shaft 12 may have a hollow end to accommodate portions of the locking device 30 when the shaft 12 is inserted into the body 16. In some embodiments, the entire shaft 12 may be hollow, portions of the shaft 12 may be hollow, or just the end of the shaft 12 may be hollow.

The locking device 30 may be used to couple a shaft 12 to numerous different items, as previously discussed. In addition to being used to couple a brush block to a removable handle, the locking device 30 may be used couple castor wheels to a cart or other object, couple sections of temporary scaffolding together, couple tent supports together, attach removable legs to a table, or any other appropriate uses.

It should be understood that the examples and embodiments described herein are for illustrative purposes only and that various modifications or changes in light thereof will be obvious to persons skilled in the art, and that such modifications or changes are to be included within the spirit and purview of this application. Moreover, the invention can take other specific forms without departing from the spirit or essential attributes thereof.

1. A locking mechanism for releasably coupling a shaft, comprising:
a body, wherein the body has a cavity adapted to receive at least one shaft;
an inner housing positioned in the cavity and having an internal cavity; and
a locking device positioned in the internal cavity of the inner housing,
wherein the locking device includes at least one pin biased towards an inner surface of the inner housing.

2. The locking mechanism of claim 1, wherein the locking device comprises a spring biased pin contained in the internal cavity of the inner housing.

3. The locking mechanism of claim 2, wherein the spring biased pin extends at least partially through at least one hole in the body so that the pin may be moved by contacting the pin outside of the body.

4. The locking mechanism of claim 2, wherein the spring biased pin is formed from a U-shaped piece of metal having the at least one pin coupled to an end of U-shaped configuration and adapted to fit within the internal cavity of the inner housing.

5. The locking mechanism of claim 1, wherein the locking mechanism may be coupled to a brush block for attaching the brush block to a handle.

6. The locking mechanism of claim 1, further comprising a plurality of ribs protruding from an inner surface of the body for contacting at least one shaft.

7. The locking mechanism of claim 6, wherein the plurality of ribs are positioned generally parallel to a longitudinal axis of the cavity in the body.

8. The locking mechanism of claim 6, wherein the plurality of ribs comprise between about 15 percent and about 35 percent of the inner surface of the cavity in the body.

9. The locking mechanism of claim 8, wherein the plurality of ribs comprise about 25 percent of the inner surface of the cavity in the body.

10. The locking mechanism of claim 1, wherein the cavity in the body is generally cylindrical.

11. The locking mechanism of claim 1, wherein the body and the inner housing are formed in one piece.

12. The locking mechanism of claim 11, wherein the body and the inner housing are formed of a plastic material.

13. The locking mechanism of claim 1, wherein the locking device is formed of metal.
